(19) United States
(12) Patent Application Publication
(10) Pub. No.: US 2022/0163995 A1
(43) Pub. Date: May 26, 2022

(54) METHOD AND SYSTEM FOR ADJUSTABLE HEIGHT KIOSK

(71) Applicant: FlashParking, Inc., Austin, TX (US)

(72) Inventors: Juan Fabian Rodriguez, Austin, TX (US); Hunter Dunbar, Austin, TX (US); Kevin Rose, Dripping Springs, TX (US)

(73) Assignee: FlashParking, Inc., Austin, TX (US)

(21) Appl. No.: 17/531,725

(22) Filed: Nov. 20, 2021

Related U.S. Application Data
(60) Provisional application No. 63/116,628, filed on Nov. 20, 2020.

(51) Int. Cl. G06F 1/16; G06V 10/22; G06V 20/54; H04W 4/44

(52) U.S. Cl. CPC G06F 1/16; G06V 10/22; G06V 2201/08; H04W 4/44; G06V 20/54

(57) ABSTRACT

A kiosk system having a sensor configured to determine features of a vehicle in proximity to the kiosk system and to move the at least a portion of the kiosk system to place it in a location and/or position convenient for the vehicle's user to interface with it. As a vehicle approaches the kiosk system, a sensor may automatically detect the height, width, and length, as well as other distinct features of the vehicle. Responsive to the detection of a vehicle and the determination of a preferred location for the kiosk's user interface, the kiosk system, or a portion thereof, may move to place the kiosk's user interface in the preferred location for the particular vehicle proximate the kiosk, so that the driver of the vehicle may easily interact with the kiosk's user interface.

### PRIORITY STATEMENT UNDER 35 U.S.C. § 119 & 37 C.F.R. § 1.78

This non-provisional application claims priority based upon prior U.S. Provisional Patent Application Ser. No. 63/116,628 filed Nov. 20, 2020, in the names of Juan Rodriguez, Hunter Dunbar, and Kevin Rose entitled “METHOD AND SYSTEM FOR ADJUSTABLE HEIGHT KIOSK,” the disclosures of which are incorporated herein in their entirety by reference as if fully set forth herein.

### BACKGROUND OF THE INVENTION

Today, motor vehicles come in a vast variety of sizes and shapes, from motorcycles to semi tractor-trailers, and everything in-between. As parking facility operators continue to transition away from staffed facilities and towards automation, they are desirous of being able to provide automation that will work effectively with as many vehicles as possible. Kiosks have become the standard point of interaction for drivers of vehicles to obtain ingress to and egress from automated parking facilities, or to otherwise interact with the operator of the parking facility. Generally, automated kiosks are stationary objects that are installed and remain in a single, fixed, position throughout the entirety of their functional lifespan. The single position in which such traditional kiosks are fixed, coupled with the significant variability of sizes and shapes of vehicles that may want to use the parking facility, often means that the user interface portion of the kiosk is not located and/or positioned in a manner that is easily accessible for all potential drivers irrespective of the vehicle that they are driving. For example, if a stationary kiosk is arranged such that its user interface is easily accessible by a person driving a low-slung sports car, then it may be very difficult to access from the window of a lifted pickup truck. In such a situation, the driver of the pickup truck may have to stretch in an uncomfortable manner, lean out of the vehicle's window, open the vehicle door, or take some other less than desirable action to effectively interface with the kiosk.

Accordingly, there is a need for kiosks having the ability to adjust the location and/or position of its user interface such that it is easily accessible by a user no matter what vehicle the user is driving. Furthermore, it would be beneficial if the kiosk could make such adjustments dynamically, responsive to the features of the particular vehicle positioned in a location for interacting with the kiosk at any given time. Such a system would allow for the kiosk to optimize the positioning of its interface for the driver of the vehicle that is using the kiosk, and thus reduce the potential inconvenience that a user may experience when trying to interact with a kiosk while in a vehicle whose configuration does not allow for easily accessing the user interface portion of a kiosk when it is in its default location/position.

### BRIEF SUMMARY OF THE INVENTION

Embodiments of the present invention relate generally to the methods and systems for adjustable height kiosk. More specifically those embodiments relate to a computer vision model or other sensor that automatically detects the height, width, and length, as well as other distinct features of the vehicle, like side mirror and window, of an approaching vehicle, motorcycle, or other mode of transport.

The kiosk may move in the desired position based on the vehicle approaching as follows: 1) the kiosk can translate along the vertical, Z axis, moving up or down relative to the ground; 2) the kiosk can translate along the horizontal, Y axis, moving closer to or further away from the vehicle; 3) the kiosk can translate along the horizontal, X axis, moving forwards or backwards along the length of the vehicle; and 4) a portion of the kiosk can rotate about a pitch axis, facing upwards towards the sky or downwards towards the ground.

The kiosk motion in question can include, but not limited to: 1) the entire kiosk “shell” or metal container; 2) a user interface portion of the kiosk; 3) only the top half of the “shell” kiosk. The kiosk may comprise a actuation system to move the kiosk. The actuation system of the kiosk may comprise one or more of 1) electronic actuators; 2) electronic servos; and 3) oil-based actuators; or 4) air-based actuators. In embodiments, the actuation system may be controlled by an independent electronic processor or controller.

The flow of the system will be as follows: 1) the computer vision or other sensor-based system will be continuously looking for a car to come into the field of view. When the vehicle comes into view the model will determine the height, width, and length, as well as vehicle type and other information about the vehicle such as window height, etc. Then, the model will make a determination of the optimal height of the kiosk. This information will be processed in milliseconds and sent to the controller managing the actuation system or actuator. 2) The controller managing the actuation system will know what the current state or position of the kiosk is and adjust the position of the kiosk when the previous vehicle is no longer at the kiosk and before the next vehicle arrives in front of the kiosk. 3) The vision system will continue looking for vehicles and create a queue of positions if it can read the required information for multiple vehicles in line.

The foregoing has outlined rather broadly certain aspects of the present invention in order that the detailed description of the invention that follows may better be understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows a schematic depiction of one embodiment of a parking management system comprising an adjustable height kiosk with a vehicle located proximate thereto;

FIG. 2 shows a schematic depiction of an alternate embodiment of a parking management system comprising an adjustable height kiosk, wherein the sensor portion of the system is separate from the kiosk;

FIG. 3 shows an exemplary embodiment of an adjustable height kiosk;

FIG. 4 is a schematic depiction of an embodiment of an adjustable height kiosk of the present invention with a vehicle located proximate thereto;

FIG. 5A through 5D show various depictions of an embodiment of an adjustable height kiosk with a user interface portion of the kiosk positioned at different heights;

FIG. 6A through 6E show various views of an embodiment of an adjustable height kiosk;

FIG. 7A through 7C show an exemplary adjustable height kiosk with its user interface in various positions relative to a vehicle located proximate thereto, including various positions along the Z and Y axes, in accordance with embodiments;

FIG. 8A and 8B show an exemplary adjustable height kiosk with its user interface in various positions relative to a vehicle located proximate thereto, including various positions along the X-axis, in accordance with embodiments; and

FIG. 9A and 9B show an exemplary adjustable height kiosk with its user interface positioned at various angles (about a pitch axis) relative to the ground, in accordance with embodiments.

### DETAILED DESCRIPTION OF INVENTION

The present invention is directed to improved methods and systems for, among other things, adjustable height parking kiosk. The configuration and use of the presently preferred embodiments are discussed in detail below. It should be appreciated, however, that the present invention provides many applicable inventive concepts that can be embodied in a wide variety of contexts other than adjustable height parking kiosk. Accordingly, the specific embodiments discussed are merely illustrative of specific ways to make and use the invention, and do not limit the scope of the invention. In addition, the following terms shall have the associated meaning when used herein:

“Actuation mechanism” means a mechanism that is part of an adjustable height kiosk which enables the controllable translation and/or rotation of a portion of the kiosk (generally the shell) along or about an axis.

“Base” means a bottom portion of a kiosk which is connected to the ground.

“Shell” means a portion of an adjustable height kiosk that comprises the kiosk's user interface which is attached to the base via the actuation mechanism, and which may be moved relative to the base via actuation of the actuation mechanism.

While the present system and method is disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

The detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

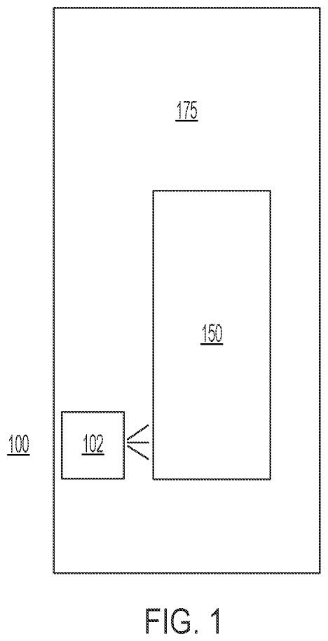

FIG. 1 shows a schematic depiction of one embodiment of a parking management system 100 for use in a parking facility 175, comprising adjustable height kiosk 102 with a vehicle 150 located proximate kiosk 102

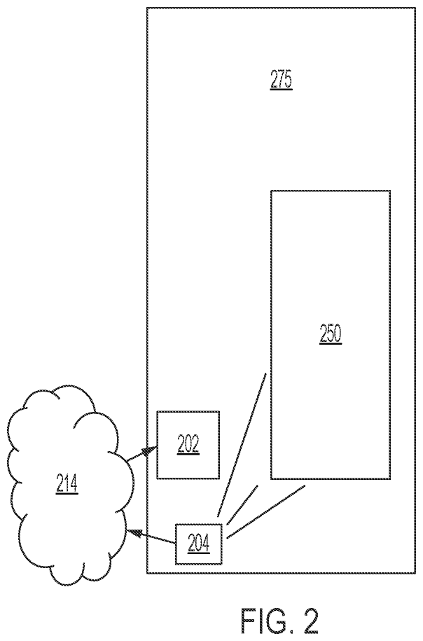

FIG. 2 shows a schematic depiction of an alternate embodiment of a parking management system 200 for use in a parking facility 275, comprising adjustable height kiosk 202 and sensor 204, wherein sensor 204 in a location distinct and remote from kiosk 202. Sensor 204 may be communicably connected to kiosk 204 via communications network 214.

In embodiments, such as the embodiment depicted in FIG. 2, sensor 204 may detect when vehicle 250 in in a position proximate kiosk 202. Sensor 204 may be further configured to detect information related to vehicle 250, and to transmit such vehicle information to kiosk 202 via communications network 214.

Embodiments of communications network 214 may comprise one or more of the Internet, a wired network, a wireless network, or any other suitable communications network known to one skilled in the art.

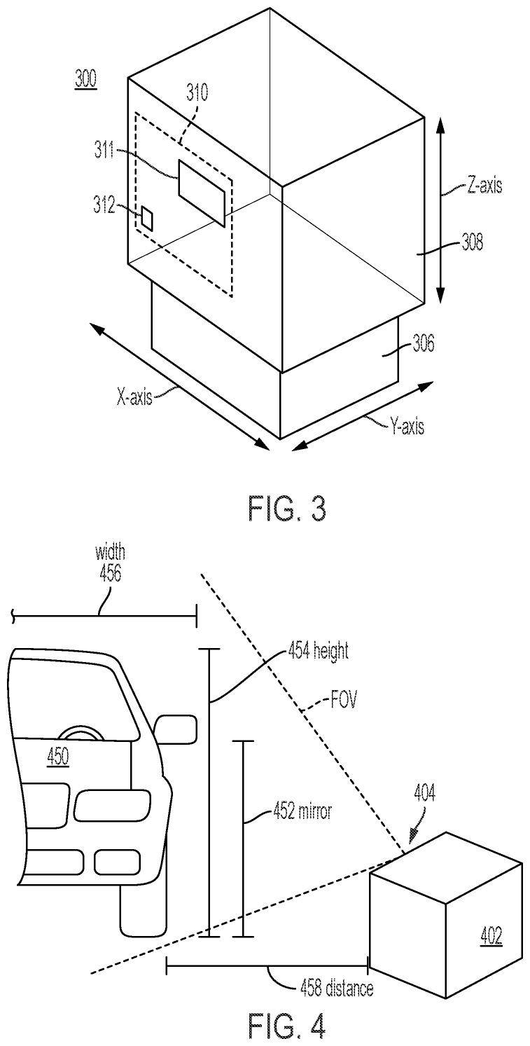

FIG. 3 shows an embodiment of adjustable height kiosk 302 comprising base 306, shell 308, and a user interface 310 consisting of a display 311, and payment mechanism 312.

In embodiments, shell 308 may be a substantially hollow structure with an aperture in the bottom surface, wherein the dimensions of the aperture and the interior dimensions of shell 308 that are larger than the exterior dimensions of base 307, such that shell 308 may be configured to allow for a portion of base 306 to be inserted into the aperture of shell 308, retained within its interior volume.

In embodiments, the sensor may be integrated into shell. Alternatively, in alternate embodiments sensor may be built into a portion of base or may be entirely physically separate from the adjustable height kiosk. In such alternate embodiments, the system may additionally provide for vehicle information to be transferred from the remote sensor to, and received by, the adjustable height kiosk, and more particularly to a controller for the actuation system of the adjustable height kiosk through a suitable communications network, such as communications network 214 shown in FIG. 2.

FIG. 4 shows a schematic depiction of an embodiment of an adjustable height kiosk, specifically adjustable height kiosk 402, comprising sensor 404. Sensor 404 may detect a vehicle, such as vehicle 450, in a location proximate adjustable height kiosk 402 and may be configured to determine vehicle information, including features of vehicle 450 including but not limited to side mirror height 452, vehicle height 454, vehicle width 456, and distance 458 from adjustable height kiosk 402.

The vehicle information may be transmitted from senor 404 to a processor (not shown) configured determine a preferred position of a user interface portion of kiosk 402 for the vehicle located proximate to kiosk 402, here vehicle 450. Once a preferred position for the user interface has been determined, a controller (not shown) may engage one or more of the actuators in the kiosk's actuation system (not shown) in order to reposition the user interface portion of kiosk 402 from its initial position to a preferred position for vehicle 450.

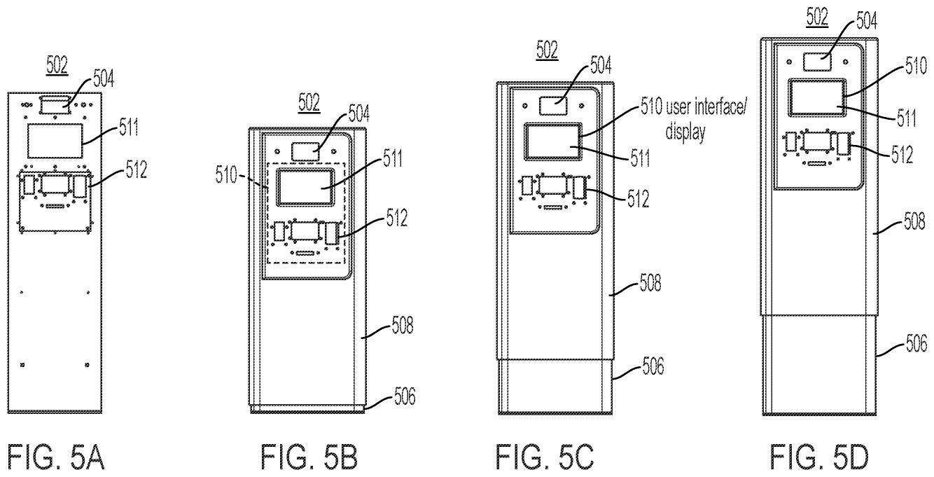

FIG. 5A through 5D show an embodiment of an adjustable height kiosk, specifically adjustable height kiosk 502, with its shell 508 at various positions along its Z-axis in the different views presented. Adjustable height kiosk 502 may comprise shell 508, base 506, actuation system (not shown), sensor 504, and user interface 510. User interface 510 be located on a portion of shell 508, and may comprise display 511, and payment mechanism 512.

Shell 508 may be configured to cover a portion of base 506 and may be translatably connected to base 506 by the actuation system (not shown). The actuation system (not shown) may be configured to translate shell 508 along the Z-axis, such that as shell 508 is translated in the +Z direction the bottom portion of base 506 may become exposed from being covered by shell 508, and as shell 508 is translated in the −Z direction the bottom portion of base 506 may become covered by shell 508.

FIG. 5A shows adjustable height kiosk 502 with a its external protective casing removed.

FIG. 5B shows adjustable height kiosk 502 with shell 508 in a lowered position, wherein the actuation system has translated shell 508 to a position with a minimal value in the Z coordinate. In such a lowered position, shell 508 may cover a majority of base 506.

FIG. 5C shows adjustable height kiosk 502 with shell 508 in a middle position. A bottom portion of base 506 can be seen, having been exposed as shell 508 due to the actuation system having translated shell 508 in the +Z direction from its position depicted in FIG. 5B.

FIG. 5D shows adjustable height kiosk 502 with shell 508 in a raised position, wherein the actuation system has translated shell 508 to a position with a maximum value in the Z coordinate. In such a raised position, shell 508 may cover only a minor portion of base 506.

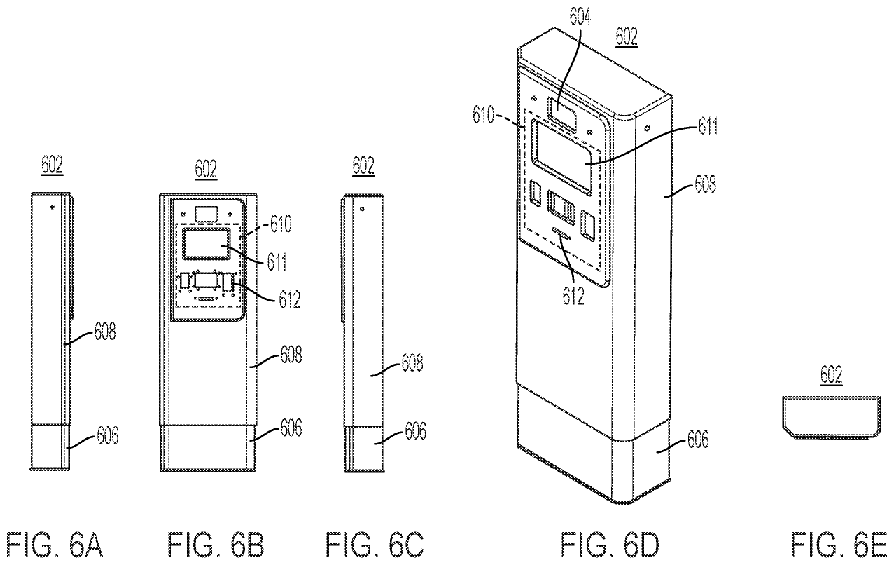

FIG. 6A through 6E show various views of an embodiment of an adjustable height kiosk, specifically adjustable height kiosk 602, with all views depicting adjustable height kiosk 602 in a consistent position.

FIG. 6A shows a first side view of adjustable height kiosk 602, with a portion of base 606 can be seen extending below shell 608.

having a display, a payment mechanism, and another embodiment of a sensor-based kiosk having the ability to move either way on the X-axis, Y-axis, and Z-axis of the present invention.

FIG. 6B shows a front view of adjustable height kiosk 602. This view shows adjustable height kiosk 602 comprising base 606, shell 608, sensor 604, and user interface 610, comprising display 611 and payment mechanism 612.

FIG. 6C shows a second side view of adjustable height kiosk 602, wherein the second side view of adjustable height kiosk 602 shown in FIG. 6C is opposite the first side view of adjustable height kiosk 602 shown in FIG. 6A.

FIG. 6D shows a perspective view of adjustable height kiosk 602.

FIG. 6E shows a top view of adjustable height kiosk 602.

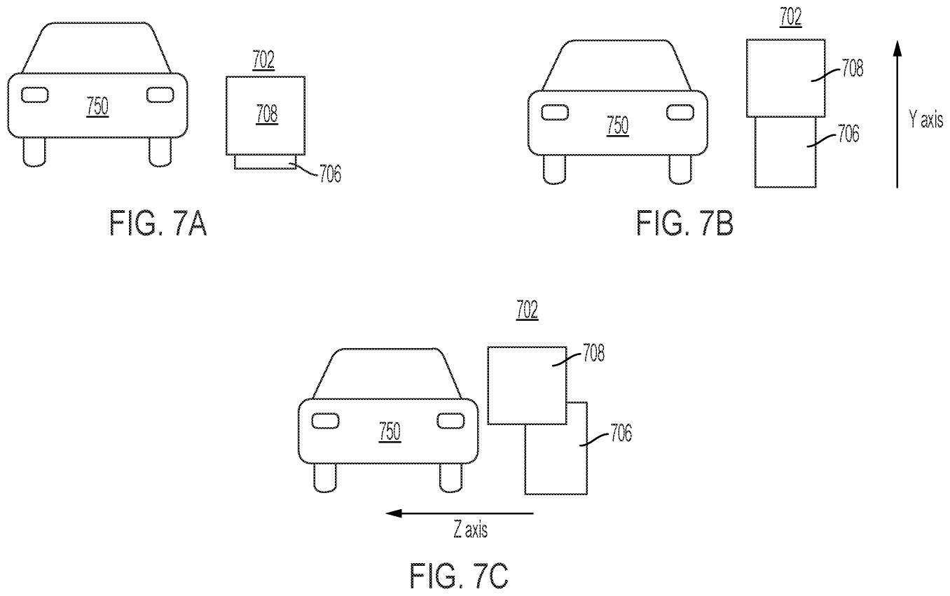

FIG. 7A through 7C show an exemplary adjustable height kiosk, namely, kiosk 702 comprising base 706 and shell 708 (with shell 708 comprising user interface (not shown)), in various positions relative to vehicle 750, which is located proximate to kiosk 702.

FIG. 7A shows kiosk 702 with shell 708 in a position comprising a low Z coordinate, resulting in shell 708 being located close to the ground. In such a low-Z position a majority of base 706 may be retained within the interior volume of shell 708. Such a low-z position may provide for drivers of short vehicles to interact with a user interface portion of shell 708 more easily.

FIG. 7B shows kiosk 702 with shell 708 in a position comprising a high Z coordinate, resulting in shell 708 being located further from the ground than it is in FIG. 7A. In such a high-Z position a majority of base 706 may be exposed below shell 708. Such a high-z position may provide for drivers of tall vehicles to interact with a user interface portion of shell 708 more easily.

FIG. 7C shows kiosk 702 with shell 708 in a position comprising a high Z coordinate and a high Y coordinate, resulting in shell 708 being offset from base 706 such that shell 708 is located closer to vehicle 750 than it is in FIG. 7B.

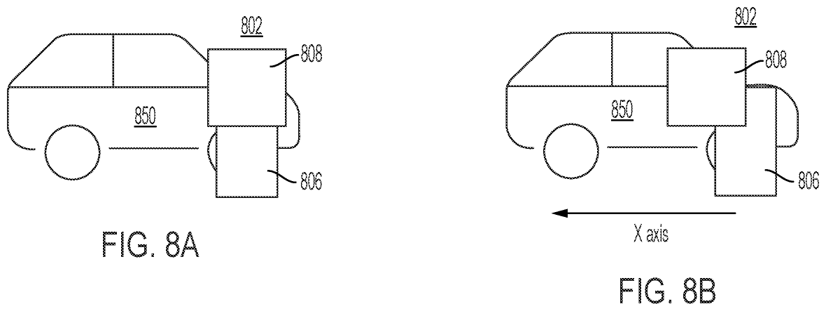

FIG. 8A and 8B show an exemplary adjustable height kiosk, namely, kiosk 802 comprising base 806 and shell 808 (with shell 808 comprising user interface (not shown)), in various positions relative to vehicle 850, which is located proximate to kiosk 802.

FIG. 8A shows kiosk 802 with shell 808 in a position comprising a high Z coordinate similar to that of FIG. 7B.

FIG. 8B shows kiosk 802 with shell 808 in a position comprising a high Z coordinate and a high X coordinate, resulting in shell 808 being offset from base 806 along the axis corresponding to the length of vehicle 850.

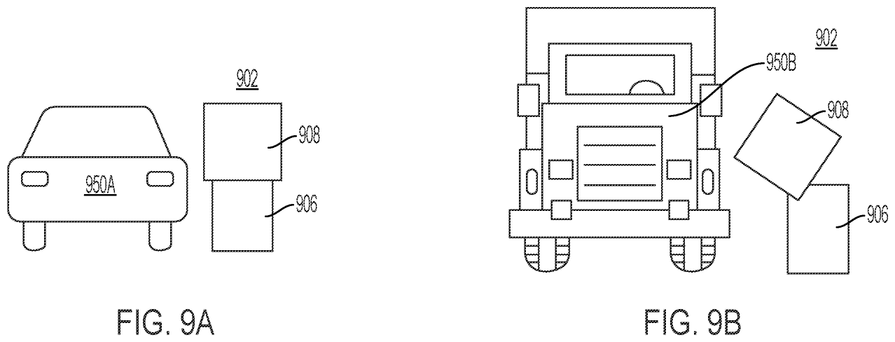

FIG. 9A and 9B show an exemplary adjustable height kiosk, namely, kiosk 902 comprising base 906 and shell 908 (with shell 908 comprising user interface (not shown)), with shell 908 positioned at various positions comprising different angles (about a pitch axis) relative to the ground.

FIG. 9A shows kiosk 902 with shell 908 in a position comprising a neutral pitch angle, wherein the side of shell 908 facing vehicle 950A is substantially perpendicular to the ground.

FIG. 9B shows kiosk 902 with shell 908 in a position comprising a positive pitch angle, wherein shell 908 has been rotated about its pitch axis such that the side of shell 908 facing vehicle 950B is angled away from the ground. Such positive pitch angle positions may provide for drivers of tall vehicles to interact with a user interface portion of shell 908 more easily, while negative pitch angle positions may provide for drivers of short vehicles to interact with a user interface portion of shell 908 more easily

To aid the Patent Office and any readers of any patent issued on this application in interpreting the claims appended hereto, the applicant wishes to note that it does not intend any of the appended claims or claim elements to invoke 35 U.S.C. 112(f) unless the words “means for” or “step for” are explicitly used in the particular claim.

We claim:

1. A kiosk system comprising:
a processor;
a user interface for providing information to and receiving input from a user;
an actuation system configured to detect a vehicle in a location proximate the kiosk system, determine a preferred position for the user interface based on the vehicle, and to move the user interface to the preferred position.

2. The kiosk system of claim 1, wherein the actuation system comprises:
a sensor configured to determine when a vehicle is in a location proximate the kiosk system, and to detect vehicle information;
a controller configured to receive the vehicle information from the sensor, to determine the preferred position responsive to the vehicle information, and to provide instructions for moving the user interface to the preferred position; and
at least one actuator configured to move the user interface responsive to receipt of instructions from the controller.

3. The kiosk system of claim 2, further comprising a communications network, and wherein the sensor is remote from the kiosk system and is configured to transmit vehicle information to the controller via the communications network.

4. The kiosk system of claim 1, wherein the actuation system is configured to translate the user interface along at least a first axis.

5. The kiosk system of claim 1, wherein the actuation system is configured to rotate the user interface about at least a first axis.

6. The kiosk system of claim 1, wherein the actuator comprises at least one of:
an electronic actuator;
an electronic servo;
an oil-based actuator; and
an air-based actuator.

7. The kiosk system of claim 1, wherein the vehicle information comprises at least one of:
a vehicle height,
a vehicle width,
a vehicle length,
a side mirror position;
a window position; and
a distance of the vehicle from the kiosk system.

8. An actuation system for moving a user interface of a kiosk, comprising:
a sensor configured to determine when a vehicle is in a location proximate the kiosk, and to detect vehicle information;
a controller configured to receive the vehicle information from the sensor, to determine a preferred position for the user interface responsive to the vehicle information, and to provide instructions for moving the user interface to the preferred position; and
at least one actuator configured to move the user interface responsive to receipt of instructions from the controller.

9. The actuation system of claim 8, wherein the actuator comprises at least one of:
an electronic actuator;
an electronic servo;
an oil-based actuator; and
an air-based actuator.

10. The actuation system of claim 8, wherein the vehicle information of the vehicle comprise at least one of:
a vehicle height,
a vehicle width,
a vehicle length,
a side mirror position;
a window position; and
a distance of the vehicle from the kiosk.

11. A method of automatically repositioning a user interface of a kiosk comprising:
11.1 detecting a vehicle in a position proximate the kiosk;
11.2 identifying at least one feature of the vehicle;
11.3 determining a preferred position for a user interface portion of the kiosk based on the at least one feature of the vehicle; and
11.4 moving the user interface to the preferred position.

12. The method of claim 11, wherein the preferred position comprises at least one of:
an X coordinate;
a Y coordinate;
a Z coordinate, and
a pitch angle.

13. The method of claim 11, wherein the at least one feature comprises at least one of:
a vehicle height,
a vehicle width,
a vehicle length,
a side mirror position;
a window position; and
a distance of the vehicle from the kiosk.

14. The method of claim 11, wherein step the moving step 11.4 comprises:
11.4.1. receiving, from a controller, instructions comprising a first coordinate of the preferred position:
11.4.2. translating the user interface along a first axis from a start position to an end position, wherein the end position comprises the first coordinate of the preferred position.

15. The method of claim 14, wherein in step 11.4.1, the first coordinate of the of the preferred position comprises a preferred position X coordinate, and wherein the instructions further comprise a preferred position Y coordinate, and a preferred position Z coordinate, and wherein, in step 11.4.2, the first axis is an X-axis, and wherein step 11.4 further comprises:
11.4.3. translating the user interface along at least one of a Y-axis and a Z-axis, to the end position, wherein the end position comprises the X, Y, and Z coordinates of the preferred position.

16. The method of claim 14, wherein the instructions from step 11.4.1 further comprise a preferred position pitch angle, and wherein step 11.4 further comprises:
11.4.3. rotating the user interface about a first rotational axis from a start position to an end position, wherein the end position comprises the preferred position pitch angle.

17. The method of claim 11, further comprising:
11.5 detecting that the vehicle no longer in a position proximate the kiosk; and
11.6 moving the user interface to a default position responsive to the detecting from step 1.5.
